(19) United States
(12) Patent Application Publication
(10) Pub. No.: US 2005/0007391 A1
(43) Pub. Date: Jan. 13, 2005

(54) Image processing method for improving the contrast in a digital display panel

(76) Inventors: Thierry Borel, Chantepie (FR); Didier Doyen, La Bouexiere (FR)

Correspondence Address: THOMSON MULTIMEDIA LICENSING INC;JOSEPH S TRIPOLI, PO BOX 5312, 2 INDEPENDENCE WAY, PRINCETON, NJ, 08543-5312, US

(21) Appl. No.: 10/840,184

(22) Filed: May 6, 2004

(30) Foreign Application Priority Data
May 7, 2003 (FR) 03/05669

(51) Int. Cl. G09G 5/10

(52) U.S. Cl. 345/690

(57) ABSTRACT

The invention relates to a method for processing an image displayed by a display device comprising at least one light source and one light valve. It comprises the following steps:
applying a compression factor C to the grey levels of the image video signal that are higher than a threshold value NG₁, the said threshold value being lower than the peak grey level value (NGₘₐₓ) of the image video signal,
adjusting the luminance of the light produced by the light source to the luminance value corresponding to the peak grey level (NGₘₐₓ) of the image after compression,
multiplying the video signal delivered to the light valve by an expansion factor D equal to the ratio of the peak grey level of the image before compression (NGₘₐₓ) over the peak grey level of the image after compression (NGₘₐₓ).

### FIELD OF THE INVENTION

The present invention relates to an image processing method for improving the contrast of the video images displayed by a front-projection or a back-projection system. The invention can be applied to video projectors comprising a light valve and a source of illumination for the said valve. The light valve may be of the reflective or transmissive type. The invention is more especially applicable to video projectors comprising a valve of the LCOS, LCD or DLP type.

### BACKGROUND OF THE INVENTION

Conventional video projectors comprising a light valve are currently capable of generating images having a contrast of between 500:1 and 1000:1 depending on the valve technology employed. In certain applications, for example digital cinema or top-of-the-range TV sets, this contrast value is not always sufficient. In order to increase this value, a known solution is to modulate the intensity of the light delivered to the valve depending on the contents of the image to be displayed. For example, if the image to be displayed shows a dark scene, the light intensity delivered to the valve is reduced whereas the level of the video signal processed by this same valve is increased in the same proportion. The contrast is now better since the number of bits in the video signal is effectively increased. It is thus possible to achieve a high contrast for the low grey levels which are always critical in TV applications.

One of the known techniques for modulating the light intensity consists in detecting the peak grey level NGₘₐₓ in the image to be displayed and in comparing this with the maximum grey level that can be displayed NG_{MAX} (=255 if the levels use 8-bit encoding):
if the grey level NGₘₐₓ is below half the grey level NG_{MAX}, the intensity of the light delivered to the valve for the image under consideration is divided by 2 and the amplitude of the video signal delivered to the control circuit of the valve is multiplied by 2,
if the grey level NGₘₐₓ is above half the grey level NG_{MAX}, the intensity of the light delivered to the valve remains at its peak value and the level of the video signal delivered to the control circuit of the valve remains unchanged.

This technique is illustrated in FIGS. 1A, 1B and 1C. FIG. 1A shows the video signal as a function of time of two images displayed during frames T and T+1, respectively. This signal is delivered to the control circuit of the valve. The voltage of the level NGₘₐₓ of the first image is lower than the voltage of the level NG_{MAX}/2 and that of the level NGₘₐₓ of the second image is higher than the voltage of the level NG_{MAX}/2. FIG. 2B shows the light intensity (luminance) delivered to the valve for each of the two images. According to the process previously defined, it is equal to Lₘₐₓ/2 for the first image and to Lₘₐₓ for the second image. The voltage of the video signal of the first image is therefore multiplied by 2 and that of the second image is kept as it is. The rendering of the video levels of dark images is thus enhanced.

This technique presents many drawbacks. The first one of them is that the image contrast is not enhanced whenever an image pixel exceeds NG_{MAX}/2. Accordingly, if the image comprises a single luminous point over a dark background, the image contrast is not increased.

In addition, there is a high current demand (during the transition from Lₘₐₓ/2 to Lₘₐₓ or vice versa) within the light source each time there is a transition from an image having a grey level NGₘₐₓ below NG_{MAX}/2 to an image having a grey level NGₘₐₓ higher than NG_{MAX}/2 or vice versa. Finally, the device responsible for modulating the light delivered to the valve is not able to switch instantaneously from Lₘₐₓ/2 to Lₘₐₓ or vice versa. Consequently, during the transition, the video signal level cannot be correctly adjusted so that areas of blurred image appear during these transition periods.

The invention proposes an image processing method that allows all or part of the above-mentioned drawbacks to be dealt with.

### SUMMARY OF THE INVENTION

The present invention relates to a method for processing an image displayed by a display device comprising at least one light source and one light valve for transmitting or reflecting all or part of the light produced by the light source, depending on the video signal of the image to be displayed, characterized in that it comprises the following steps:
applying a compression factor C to the grey levels of the image video signal that are higher than a first threshold value, the said first threshold value being lower than the peak grey level value of the image video signal,
adjusting the luminance of the light produced by the light source to the luminance value corresponding to the peak grey level of the image after compression, and
multiplying the video signal delivered to the light valve by an expansion factor D equal to the ratio of the peak grey level of the image before compression to the peak grey level of the image after compression.

Accordingly, the voltage dynamic range of the grey levels above the said first threshold value is compressed and the dynamic range thus gained is reassigned to the whole image signal.

The invention also relates to a device for displaying an image comprising:
a light source for producing light,
a light valve for transmitting or reflecting all or part of the light produced by the light source,
a circuit for controlling the valve, receiving a video signal of the image to be displayed and delivering a control signal to the said valve that is representative of the image to be displayed,
   characterized in that the control circuit comprises:
means for applying a compression factor C to the grey levels of the image video signal that are higher than a first threshold value, the said first threshold value being lower than the peak grey level value of the image video signal,
means for adjusting the luminance of the light produced by the light source to the luminance value corresponding to the peak grey level of the image after compression,
means for multiplying the video signal delivered to the light valve by an expansion factor D equal to the ratio of the peak grey level of the image before compression to the peak grey level of the image after compression.

### BRIEF DESCRIPTION OF THE DRAWINGS

The invention will be better understood and other features and advantages will become apparent upon reading the description that follows which makes reference to the appended drawings, among which:

FIGS. 1A to 1C are timing diagrams illustrating the prior art;

FIG. 2 illustrates the compression of the grey levels above a threshold grey level NG₁ according to the invention;

FIG. 3 is a schematic diagram of a video projector in which the method of the invention could be implemented;

FIG. 4 shows the operations carried out in a control circuit of the video projector in FIG. 3;

FIG. 5 shows an example of a calculation of the threshold above which the grey levels of the image are compressed; and

FIGS. 6A to 6C, to be compared with FIGS. 1A to 1C, are timing diagrams illustrating the method of the invention.

### DESCRIPTION OF PREFERRED EMBODIMENTS

According to the invention, the grey levels of a restricted number of image pixels (which are the pixels having the highest grey levels in the image) are compressed and the gain in voltage dynamic range is reassigned to the whole image. The compression of the higher grey levels of the image allows the intensity of the light delivered to the light valve to be reduced and the level of the video signal delivered to the valve to then be increased in the same proportion. The contrast of the displayed image can thus be enhanced.

In the remainder of the description, NGₘₐₓ denotes the peak grey level of the pixels of the image to be displayed before compression and NGₘₐₓ denotes the peak grey level of the pixels of the image to be displayed after compression. In addition, L(NG) denotes the luminance associated with the grey level NG.

According to the invention, the following steps are carried out:
applying a compression factor C to the grey levels of the image video signal that are higher than a threshold value NG₁ with NG₁<NGₘₐₓ;
adjusting the luminance of the light produced by the light source to the luminance value corresponding to the peak grey level of the image NGₘₐₓ after compression;
multiplying the voltage level of the video signal delivered to the light valve by an expansion factor D equal to the ratio of the peak grey level NGₘₐₓ of the image before compression to the peak grey level NGₘₐₓ of the image after compression.

According to one particular embodiment, the threshold NG₁ is, for example, defined as being the value of the lowest grey level of the X brightest pixels of the image, X being a predefined percentage of the number of pixels in the image. For an image comprising 1920×1080 pixels, X is, for example, equal to 10%, or 1920×1080/10 pixels. This threshold varies depending on the image to be displayed. An example of calculation of this threshold will be described below with reference to FIG. 5. In this embodiment, the threshold NG₁ is higher or lower depending on whether the image to be displayed is brighter or darker. Preferably, the threshold NG₁ is taken as greater than or equal to

$$\frac{{NG}_{MAX}}{2}$$

where NG_{MAX} is the peak grey level that can be displayed by the panel.

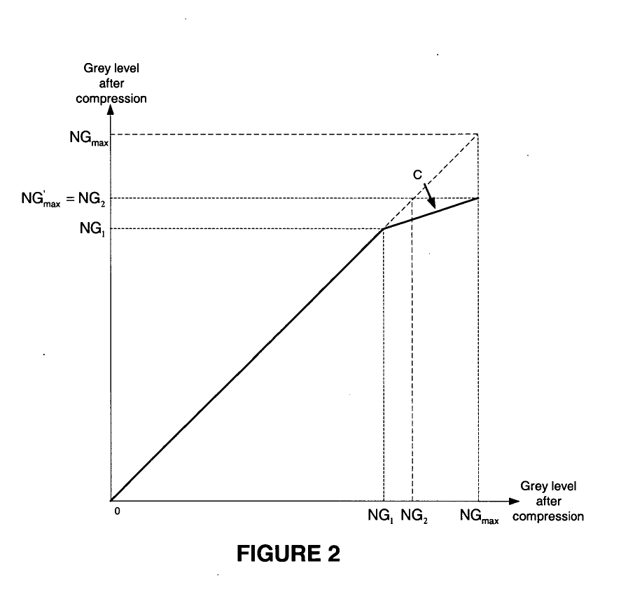

FIG. 2 illustrates the application of a compression factor C to the grey levels of an image situated above the threshold NG₁. This figure has an abscissa representing the grey levels of the image before compression and an ordinate representing the grey levels after compression; in this figure

$$C = \frac{{NG}_{max} - {NG}_{1}}{{NG}_{2} - {NG}_{1}}$$

where NG₂ corresponds to the peak grey level after compression NGₘₐₓ.

This compression of the higher grey levels has the effect of reducing the luminance gap between the grey levels above NG₁. The luminance of the light required to display the image is therefore brought down to a value L(NGₘₐₓ) corresponding to the luminance value normally associated with the grey level NG₂ with NG₁<NG₂<NGₘₐₓ.

The closer the grey level NG₂ is to NG₁, the higher the compression factor is. According to one particular embodiment, the grey level NG₂ can be a function of the threshold NG₁. For example, NG₂ will be taken as equal to the arithmetic mean of NG₁ and NGₘₐₓ, or:

$${NG}_{2} = \frac{{NG}_{1} + {NG}_{max}}{2}$$

In this case, the lower the level NG₁ relative to NGₘₐₓ is, the lower will also be the level NG₂ and the lower will be the luminance value L(NGₘₐₓ)=L(NG₂).

According to another particular embodiment, the factor C can be kept constant whatever the value of NG₁. NG₂ will thus increase in the same proportion as NG₁.

This reduction in the intensity of light delivered to the light valve (L(NG₂) instead of L(NG_{MAX}) where NG_{MAX} is the peak grey level that can be displayed by the screen) allows the multiplication of the amplitude of the video signal after compression by an expansion factor equal to

$$\frac{{NG}_{MAX}}{{NG}_{max}} = \frac{{NG}_{MAX}}{{NG}_{2}} .$$

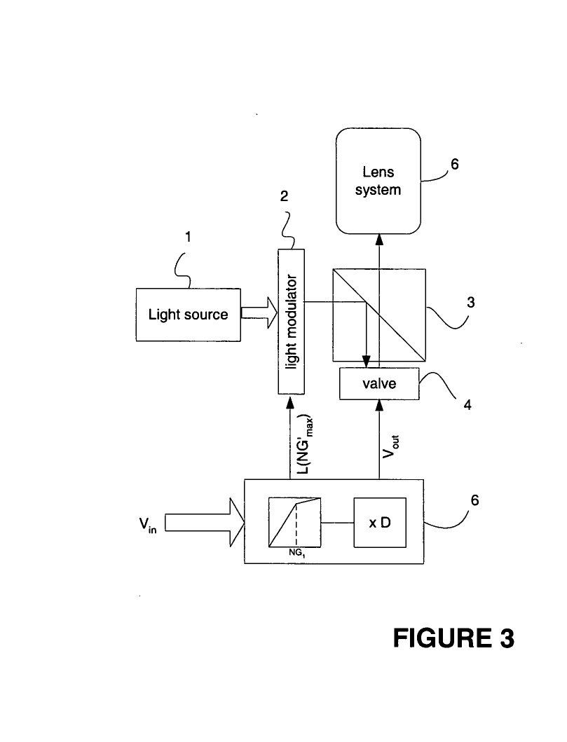

A video projector in which the method of the invention is implemented is illustrated in FIG. 3. This projector comprises a light source 1, a light modulator 2 for modulating the intensity of the light produced by the light source 1 as a function of the contents of the image to be displayed, an optical system 3 for sending the light output from the light modulator 2 towards a valve 4 and for sending the image produced by the valve 4 towards a lens system 6. The light modulator 2 and the light valve 4 are controlled by a control circuit 5 which receives the video signal Vᵢₙ of the image to be displayed. It calculates a signal Vₒᵤₜ to be delivered to the light valve 4 and the luminance value L(NGₘₐₓ) to be delivered to the light modulator 2.

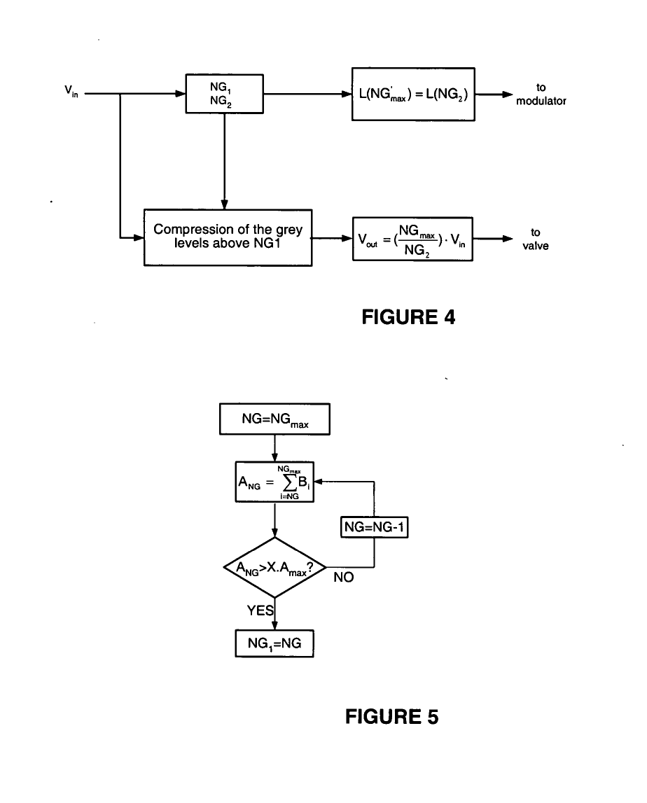

A block diagram indicating the steps performed in the control circuit 6 for implementing the method of the invention is shown in FIG. 4.

The control circuit calculates firstly the threshold NG₁. An example of calculation of the threshold NG₁ is given in FIG. 5. In this figure, NG denotes a grey level index, B_{NG} denotes the number of pixels having a grey level NG in the image under consideration and A_{NG} denotes a number of pixels such that:

$${A}_{NG} = {\sum }_{i = NG}^{{NG}_{max}} {B}_{i}$$

with

$${A}_{max} = {\sum }_{i = 0}^{{NG}_{max}} {B}_{i}$$

(Aₘₐₓ is equal to the number of pixels in the image).

In order to define NG₁, starting from the grey level NG=NGₘₐₓ, NG is decremented until A_{NG}>X.Aₘₐₓ where X is a percentage of the total number of pixels in the image. X is, for example, equal to 10%. NG is thus decremented until A_{NG}>Aₘₐₓ/10. The threshold NG₁ is then taken as equal to the value NG obtained.

Again referring to FIG. 4, the control circuit subsequently calculates the value of the grey level NG₂. It is, for example, equal to the arithmetic mean value of NG₁ and NGₘₐₓ as previously indicated.

The luminance value corresponding to the value normally associated with the value of grey level NG₂ is sent to the light modulator 2. The intensity of light delivered to the valve 4 by the modulator 2 is thus fixed at L(NGₘₐₓ) for this image.

The control circuit 5 also transforms the video signal Vᵢₙ by compressing the grey levels above NG₁ as shown in FIG. 3. This modified signal is then multiplied by an expansion factor

$$D = \frac{{NG}_{max}}{{NG}_{2}}$$

in order to reassign the voltage dynamic range unused by the higher levels to the whole video signal. The resulting signal, denoted Vₒᵤₜ, is delivered to the light valve 4. This transformation of Vᵢₙ to Vₒᵤₜ thus allows the voltage dynamic range of the grey levels above NG₁ to be compressed to the benefit of the grey levels below NG₁.

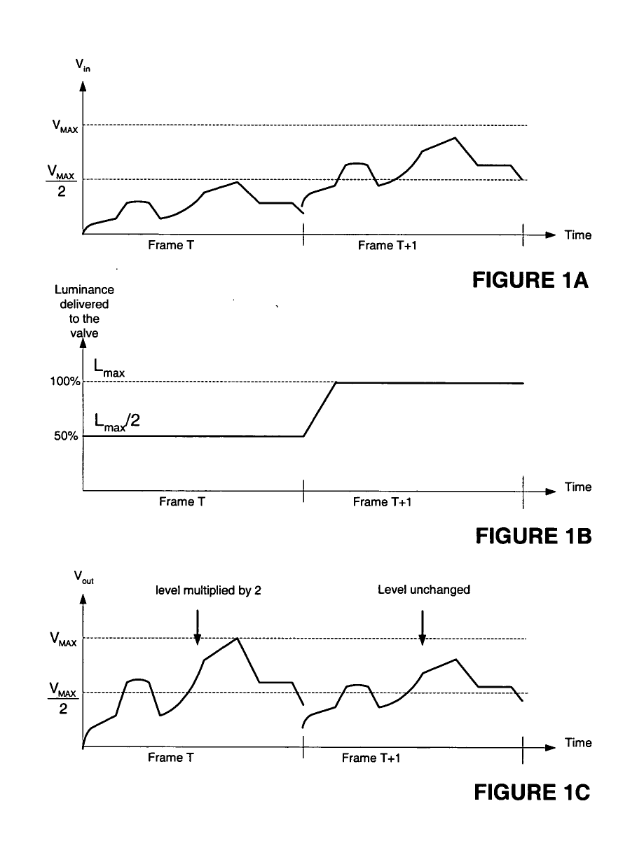

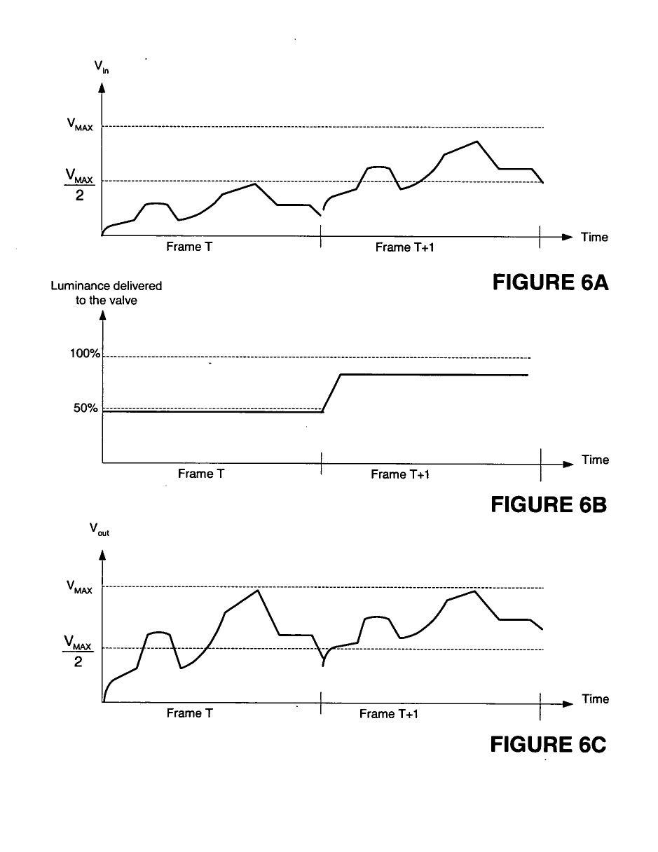

The results of the method of the invention are illustrated by the timing diagrams in FIGS. 6A to 6C which are to be compared with FIGS. 1A to 1C. FIG. 6A is identical to FIG. 1A. FIG. 6B shows the luminance value of the light delivered to the light valve 4. Since the image displayed during the frame T does not comprise any grey level higher than

$$\frac{{NG}_{MAX}}{2}$$

(lower limit of NG₁), no grey levels in this image are compressed. The video signal of this image is however multiplied by an expansion factor that is close to 2 in the present case; this is the image of the frame T+1 which does comprise grey levels higher than

$$\frac{{NG}_{MAX}}{2} .$$

The highest grey levels in this image are therefore compressed. The image video signal is multiplied by a smaller expansion factor than that of the T image.

It will be clear to those skilled in the art that other methods of calculating the values NG₁ and NG₂ than those described herein above could be employed in order to implement the method of the invention.

1. Method for processing an image displayed by a display device comprising at least one light source and one light valve for transmitting or reflecting all or part of the light produced by the light source, depending on the video signal of the image to be displayed, characterized in that it comprises the following steps:
applying a compression factor C to the grey levels of the image video signal that are higher than a first threshold value (NG₁), the said first threshold value (NG₁) being lower than the peak grey level value (NGₘₐₓ) of the image video signal,
adjusting the luminance of the light produced by the light source to the luminance value corresponding to the peak grey level (NGₘₐₓ) of the image after compression,
multiplying the video signal delivered to the light valve by an expansion factor D equal to the ratio of the peak grey level of the image before compression (NGₘₐₓ) to the peak grey level of the image after compression (NGₘₐₓ).

2. Method according to claim 1, characterized in that the first threshold value (NG₁) is equal to the lowest grey level of the X brightest pixels of the image to be displayed, X being a predefined percentage of the number of pixels in the image.

3. Method according to claim 2, characterized in that the compression factor C is taken equal to the ratio of the difference between the peak grey level valve (NGₘₐₓ) of the image before compression and the said first threshold value (NG₁) to the difference between a second threshold value (NG₂) and the said first threshold value (NG₁), the second threshold value (NG₂) corresponding to the value of the peak grey level (NGₘₐₓ) of the image after compression.

4. Method according to claim 3, characterized in that the second threshold value (NG₂) is dependent on the first threshold value (NG₁).

5. Method according to claim 4, characterized in that the second threshold value (NG₂) is the arithmetic mean value of the first threshold value (NG₁) and the peak grey level value (NG_{MAX}) that can be displayed by the said display device.

6. Method according to claim 4, characterized in that the compression factor C is constant whatever the said first threshold value (NG₁), the difference between the said second threshold value (NG₂) and the said first threshold value (NG₁) thus being constant.

7. Method according to one of claims 1, characterized in that the first threshold value (NG₁) is greater than or equal to half the maximum value of grey level (NG_{MAX}) that can be displayed by the said display device.

8. Device for displaying an image comprising:
a light source (1) for producing light,
a light valve (4) for transmitting or reflecting all or part of the light produced by the light source,
a circuit (6) for controlling the valve, receiving a video signal of the image to be displayed and delivering a control signal to the said valve that is representative of the image to be displayed,
characterized in that the control circuit comprises:
means for applying a compression factor C to the grey levels of the image video signal that are higher than a first threshold value (NG₁), the said first threshold value (NG₁) being lower than the peak grey level value (NGₘₐₓ) of the image video signal,
means for adjusting the luminance of the light produced by the light source to the luminance value corresponding to the peak grey level (NGₘₐₓ) of the image after compression,
means for multiplying the video signal delivered to the light valve by an expansion factor D equal to the ratio of the peak grey level of the image before compression (NGₘₐₓ) to the peak grey level of the image after compression (NGₘₐₓ).

9. Display device according to claim 8, characterized in that the light valve is a liquid crystal valve.

10. Display device according to claim 8, characterized in that the light valve is a micro-mirror valve.
